(19) United States
(12) Patent Application Publication
(10) Pub. No.: US 2005/0165655 A1
(43) Pub. Date: Jul. 28, 2005

(54) Web Service distribution system over the World Wide Web enabling authorized third parties to track the distribution of and the billing for such Web Services provided by suppliers to users

(75) Inventors: Walid M. Kobrosly, Round Rock, TX (US); Nadeem Malik, Austin, TX (US); Marques Benjamin Quiller, Pflugerville, TX (US); Avijit Saha, Somers, NY (US)

Correspondence Address: Mark E. McBurney;International Business Machines Corporation, Intellectual Property Law Dept., Internal Zip 4054, 11400 Burnet Road, Austin, TX, 78758, US

(73) Assignee: International Business Machines Corporation, Armonk, NY (US)

(21) Appl. No.: 10/765,780

(22) Filed: Jan. 27, 2004

(51) Int. Cl. G06F 17/60

(52) U.S. Cl. 705/26

(57) ABSTRACT

A World Wide Web (Web) communication network with user access via a plurality of data processor controlled interactive Web display stations having a Web Service distribution system formed by the combination of a registry of platform independent Web Services available as integratable Web Service modules distributable over the Web from registered suppliers to requesting users, an implementation enabling suppliers to register said integrated Web Service modules being offered by said suppliers for distribution to users at said Web station, an implementation enabling users of said Web Services to request distribution of such services to their respective Web stations, an implementation enabling said suppliers of said Web Services to bill user provided with said Web Services to bill requesting users for said Web Services provided over the Web, and an implementation enabling third parties to track said distribution and said billing via the Web.

### TECHNICAL FIELD

The present invention relates to distribution of data over the World Wide Web (Web), and particularly to the distribution of a specific types of Web documents known as Web Services items.

### BACKGROUND OF RELATED ART

The past decade has been marked by a technological revolution driven by the convergence of the data processing industry with the consumer electronics industry. The effect has, in turn, driven technologies that have been known and available but relatively quiescent over the years. A major one of these technologies is the Internet or Web. The convergence of the electronic entertainment and consumer industries with data processing exponentially accelerated the demand for wide ranging communication distribution channels, and the Web or Internet, which had quietly existed for over a generation as a loose academic and government data distribution facility, reached “critical mass” and commenced a period of phenomenal expansion. With this expansion, businesses and consumers have direct access to all matter of databases providing documents, media and computer programs through related distribution of Web documents, e.g. Web pages or electronic mail. Because of the ease with which documents are distributable via the Web, it has become a major source of data. Virtually all databases of public information throughout the world are accessible and able to be searched via the Web.

The ease with which great volumes of data may be searched from a computer attached to the Internet and equipped with a Web browser has led to the development of widespread electronic commerce over the Web. At the present time, it is becoming very rare to find a business organization of any kind that does not transact some aspect of the business via the Web. As consumers and businesses become more familiar and comfortable with Web transactions, they become more and more willing to try the Web for other commerce.

Another technology, the development of which has been accelerated by the Web, is object oriented programming. The computer and communications industries are extensively participating in the development and upgrading of Java or like object oriented programming that may be distributed over the Internet or Web or like private networks. For details and background with respect to the Java system, reference may be made to a typical text, Just Java, 2nd Edition, Peter van der Linden, Sun Microsystems, 1997.

With the development and rapid expansion of the Web and other like networks, hypertext markup languages became the primary vehicle for distribution of data over such networks. A basic hypertext language, HTML, is described in detail in the above-entitled Just Java text, particularly at Chapter 7, pp. 249-268, dealing with the handling of Web pages; and also in the text, Mastering the Internet, G. H. Cady et al., published by Sybex Inc., Alameda, Calif., 1996, particularly at pp. 637-642, on HTML in the formation of Web pages. The Web pages are implemented so as to be used for the distribution of Web documents containing text, images, both still and moving, and sound, as well as programs.

The above three rapidly evolving technologies: the Web distribution network; object oriented programming; and hypertext markup languages have now all been correlated into a system for distribution and exchange via the Web of data between any two computer applications. The system is specifically known as Web Services. The system is based on both suppliers of the data in the form of text based documents and the users of such data conforming to several industry standards developed by the World Wide Web Consortium (W3C). The primary standard is Extensible Markup Language (XML) for defining data and creating markup languages in the form of XML tags. The resulting XML documents are text based and, thus, may be processed on any platform in the distribution of the Web Services. Accordingly, suppliers who wish to offer their Web Services must qualify the proposed services according to the following standards:
XML: a hypertext markup language extensively used in the distribution of Web Services and other electronic business components over the Web. (For a basic description of Web Services, reference is made to the text Web Services, A Technical Introduction, H. M. Deitel et al., published 2003, Prentice Hall, Upper Saddle River, for general information and particularly to Appendix A, pp. 319-334.)
(SOAP) Simple Object Access Protocol: a protocol established to enable the programming objects that form part of the XML items being distributed to communicate with each other via messages (Chapter 6 of the above text).
(UDDI) Universal Description, Discovery, and Integration Registry: where suppliers or developers may list their Web Services offered for distribution, i.e. advertise their Web Services.
(WSDL) Web Services Description Language: an XML language used by suppliers and developers for describing the offered Web Services on the UDDI Registry.
Java Web Services: an object oriented platform for Web Services distribution of modular object oriented items (described in Appendix C of the above-mentioned text).

To users and suppliers of Web Services who are qualified in all of the above required standards, the system has been efficient in the distribution of services over the Web. The items have been selected by interested users from the UDDI, distributed over the Web from the suppliers to such requesting users, and subsequently billed to and tracked, if necessary, by the requesting user. This has been done with a minimum of human, i.e. person-machine intervention being necessary; which, of course, is one the advantages and goals of Web distribution.

However, as a wider spectrum of users and even suppliers become interested in Web Services, it will have to be recognized that many in this wider group will not have the computer sophistication needed to easily conform their products and needs to the above protocols necessary to establish Web Services. Still other potential users and suppliers will not be in a position to invest their own business resources and time in developing the implementation of the above requisite protocols.

Consequently, in Web Services, as in many other computer related technologies, the present invention has recognized the need to have implementations of Web Services technology that will accommodate the Web sophisticated third parties whom users and suppliers select to be their Web Services facilitators.

### SUMMARY OF THE PRESENT INVENTION

The present invention provides a Web communication network with user access via a plurality of data processor controlled interactive Web display stations having a Web Service distribution system formed by the combination of a registry of platform independent Web Services available as integratable Web Service modules distributable over the Web from registered suppliers to requesting users, means enabling suppliers to register said integrated Web Service modules being offered by said suppliers for distribution to users at said Web station, means enabling users of said Web Services to request distribution of such services to their respective Web stations, means enabling said suppliers of said Web Services to bill the user provided with said Web Services to bill requesting users for said Web Services provided over the Web, and means enabling third parties to track said distribution and said billing via the Web.

This enabled third party is preferably an independent Web services manager or facilitator for either one of the suppliers or one of the users. This third party facilitator function could also be performed by the existing Web or Internet Service Provider (ISP). The basic Web Services system would, of course, conform to all of the above-mentioned Web Services protocols, including the UDDI registry for supplier offered services, the XML document creation standard and SOAP and Java Web Services object standards.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a data processing system including a central processing unit and network connections via a communications adapter that is capable of implementing the receiving display stations on which the received user requested Web documents, including Web Services, may be received. The system may be used for all of the other computers used in the present invention, including conventional servers used throughout the Web for Web access servers, source database servers, as well as the computers supporting the UDDI and the third party Web Services managers, as well as the service providers in accordance with this invention;

FIG. 2 is a generalized diagrammatic view of a Web portion upon which the present invention may be implemented;

FIG. 3 is a general flowchart of a program set up to implement the present invention for a third party to track the distribution of and billing for Web Services; and

FIG. 4 is a flowchart of an illustrative run of the program set up in FIG. 3.

### DETAILED DESCRIPTION OF THE PREFERRED EMBODIMENT

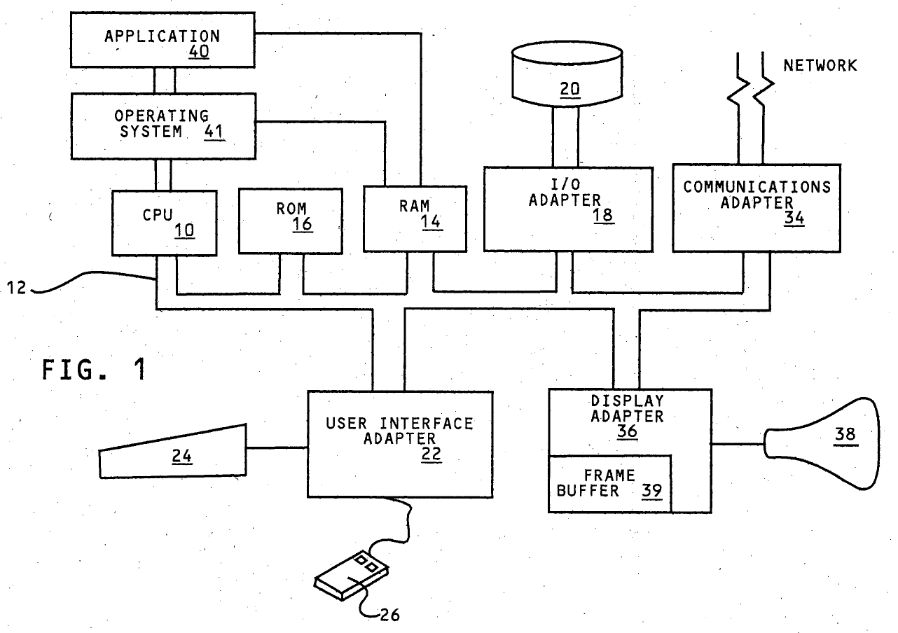

Referring to FIG. 1, a typical data processing terminal is shown that may function as the receiving display terminal on the Web of the user who ordered the Web Services item, as well as the sending terminal of the supplier of the Web Services item. The system may also be used for conventional servers used throughout the Web for Web servers including the servers of the ISP, as well as the servers used by the third parties, e.g. Web facilities providers or outside Web management.

Referring to FIG. 1, a central processing unit (CPU) 10, such as one of the PC microprocessors or workstations, e.g. RISC System/6000™ series available from International Business Machines Corporation (IBM), or Dell PC microprocessors, is provided and interconnected to various other components by system bus 12. An operating system 41 runs on CPU 10, provides control and is used to coordinate the function of the various components of FIG. 1. Operating system 41 may be one of the commercially available operating systems, such as IBM's AIX 6000™ operating system or Microsoft's WindowsXP™ or Windows2000™, as well as UNIX and other IBM AIX operating systems. Application programs 40, controlled by the system, are moved into and out of the main memory Random Access Memory (RAM) 14. These programs include all of the Web Services programs discussed above for the practice of the present invention that will also be described hereinafter for operations wherein the system of FIG. 1 functions as the user or supplier Web terminal for respectively receiving and sending Web Services, as well as the various servers used by service providers and outside or third party Web facilities management in tracking and controlling distribution in accordance with the present invention. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with an outside Internet or Web network as appropriate. I/O devices are also connected to system bus 12 via user interface adapter 22 and display adapter 36. Keyboard 24 and mouse 26 are all interconnected to bus 12 through user interface adapter 22. It is through such input devices that the user may interactively relate to the programs of this invention. Display adapter 36 includes a frame buffer 39 that is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through keyboard 24 or mouse 26 and receiving output information from the system via display 38.

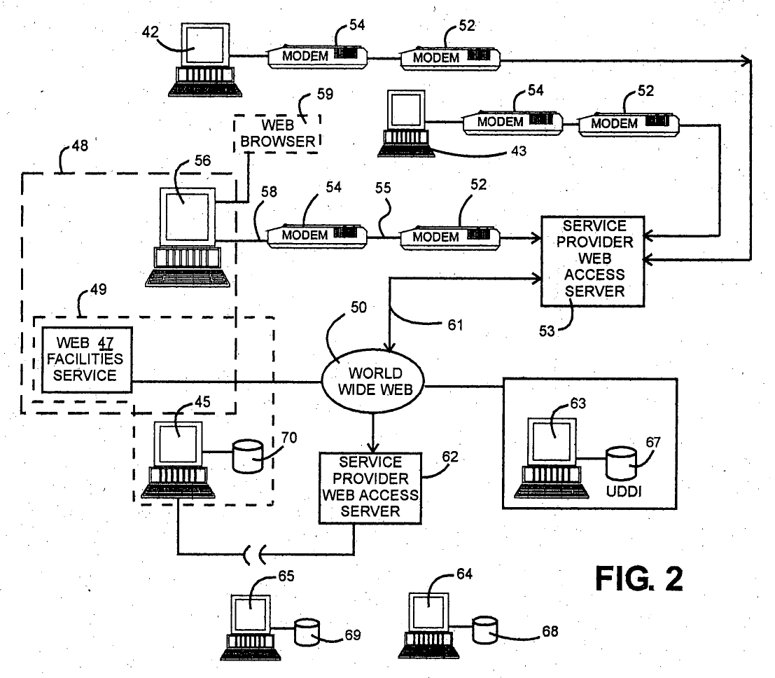

A generalized example of the practice of the present invention involving outside third party access to standard selected supplier to user Web Services XML modules provided via the Web will be considered with respect to FIG. 2 that shows a generalized portion of the Web. First, it should be helpful to understand from a more general perspective the various elements and methods that may be related to the present invention. Since a major aspect of the present invention is directed to Web hypertext documents, such as Web documents and media and application program content therein, transmitted over networks, an understanding of the Internet or Web and its operating principles would be helpful. Reference has also been made to the applicability of the present invention to a global network, such as the Internet or Web. For details on Internet nodes, objects and links, reference is made to the above-mentioned text, Mastering the Internet.

The Internet or Web is a global network of a heterogeneous mix of computer technologies and operating systems. Higher level objects are linked to lower level objects in the hierarchy through a variety of network server computers. These network servers are the key to network distribution, such as the distribution of Web pages and related documentation. In this connection, the term “documents” is used to describe data packets or items transmitted over the Web or other networks and is intended to include Web pages with displayable text, graphics and other images, as well as computer programs. This displayable information may be still, in motion or animated, e.g. animated GIF images.

Web documents are conventionally implemented in HTML language, which is described in detail in the above-referenced text, Just Java, particularly at Chapter 7, pp. 249-268, dealing with the handling of Web pages; and also in the text, Mastering the Internet, particularly at pp. 637-642, on HTML in the formation of Web pages. In addition, aspects of this description will refer to Web browsers. A general and comprehensive description of browsers may be found in the above-mentioned Mastering the Internet text at pp. 291-313. More detailed browser descriptions may be found in the text, Internet: The Complete Reference, Millennium Edition, M. L. Young et al., Osborne/McGraw-Hill, Berkeley Calif., 1999, Chapter 19, pp. 419-454, on the Netscape Navigator; Chapter 20, pp. 455-494, on the Microsoft Internet Explorer; and Chapter 21, pp. 495-512, covering Lynx, Opera and other browsers. Within this environment, Web Services distribution has evolved in recent years. Web Services are based on both suppliers of the data in the form of text based documents and the users of such data conforming to several industry standards developed by the W3C. The primary standard is XML for defining data and creating markup languages in the form of XML tags. The resulting XML documents are text based and, thus, may be processed on any platform in the distribution of the Web Services. Accordingly, suppliers who wish to offer their Web Services must qualify the proposed services according to the following standards:
XML: a hypertext markup language extensively used in the distribution of Web Services and other electronic business components over the Web. (For a basic description of Web Services, reference is made to the text Web Services, A Technical Introduction, H. M. Deitel et al., published 2003, Prentice Hall, Upper Saddle River, for general information and particularly to Appendix A, pp. 319-334.)
(SOAP) Simple Object Access Protocol: a protocol established to enable the programming objects that form part of the XML items being distributed to communicate with each other via messages (Chapter 6 of the above text).
(UDDI) Universal Description, Discovery, and Integration Registry: where suppliers or developers may list their Web Services offered for distribution, i.e. advertise their Web Services.
(WSDL) Web Services Description Language: an XML language used by suppliers and developers for describing the offered Web Services on the UDDI Registry.
Java Web Services: an object oriented platform for Web Services distribution of modular object oriented items (described in Appendix C of the above-mentioned text).

To users and suppliers of Web Services who are qualified in all of the above required standards, the system has been efficient in the distribution of services over the Web. The items have been selected by interested users from the UDDI, distributed over the Web from the suppliers to such requesting users and subsequently billed to and tracked if necessary by the requesting user.

In light of this background, reference is made to FIG. 2 showing a portion of the Web or Internet set up for the distribution of Web Services in accordance with the present invention. The distribution of Web Services is controlled by server computer 63 that controls and is supported by UDDI 67 that includes the registry of qualified Web Services suppliers. These registered suppliers are represented by Web computer stations 64, 65 and 45, each respectively supported by databases 68, 69 and 70. The suppliers may be connected into the Web 50 through any conventional Web access server 62, as in the present example is provided through a Web or ISP. Similarly, qualified users as represented by Web computer stations 42, 43 and 56 are connected to Web 50. For purposes of the present embodiment, let computer station 56 serve as a typical receiving Web display station through which a user may access Web documents, including the Web Services XML documents considered in the present invention.

Reference may be made to the above-mentioned Mastering the Internet, pp. 136-147, for typical connections between local Web stations to the Web via network servers; any of which may be used to implement the system on which this invention is used. The system embodiment of FIG. 2 has a host-dial connection. Such host-dial connections have been in use for over 30 years through network access servers 53 that are linked 61 to the Web 50. The Web server 53 may be maintained by a Web or ISP to Web computer station 56. Such Web or ISPs are described generally in the above-mentioned text, Internet: The Complete Reference. Millennium Edition at pages 14-18. The Web server 53 is accessed by the receiving station 56 through a normal dial-up telephone linkage 58 via modem 54, telephone line 55 and modem 52. Any conventional digital or analog linkages, including wireless connections, are also usable. Web browser program 59 functions to access the service provider 53. Receiving computer stations 42 and 43 connected to the service provider server 53 function similarly to station 56.

Web services may be distributed conventionally with this arrangement. Suppliers 45, 64 and 65 that satisfy the above discussed Web Services protocols are registered in UDDI 67/server registry from which users at stations 42, 43 and 56 may select and request, via a Web browser 59, appropriate Web Services from a selected supplier. These Web Services are then transmitted over the Web 50 in an XML hypertext document format containing objects embodying the Web Service, e.g. applications program to the requesting user who is then billed via the Web and in turn provides for payment via the Web. If there are billing questions or other tracking questions regarding requested Web Services, the requesting user is dealt with directly via the Web.

In an example involving the present invention, a qualified user, e.g. at computer station 56, designates a surrogate, e.g. Web facilities service 47, to act on behalf of the user at station 56 for all billing and Web Service item questions. Dashed line 48 is intended to show this relationship. Thus, Web facilities service 47 may act in all distribution tracking and bill payment matters. It should also be noted that alternatively the user at Web station 56 may designate his ISP 53 to perform this third party or surrogate function. Similarly, a qualified supplier, e.g. at computer station 45, designates a surrogate, e.g. Web facilities service 47, to act on behalf of the supplier at station 45 for all billing and Web Service item questions. Dashed line 49 is intended to show this relationship. Thus, Web facilities service 47 may act on behalf of supplier station 45 in all distribution tracking and bill payment matters. It should also be noted that alternatively the supplier at Web station 45 may designate his ISP 62 to perform this third party or surrogate function.

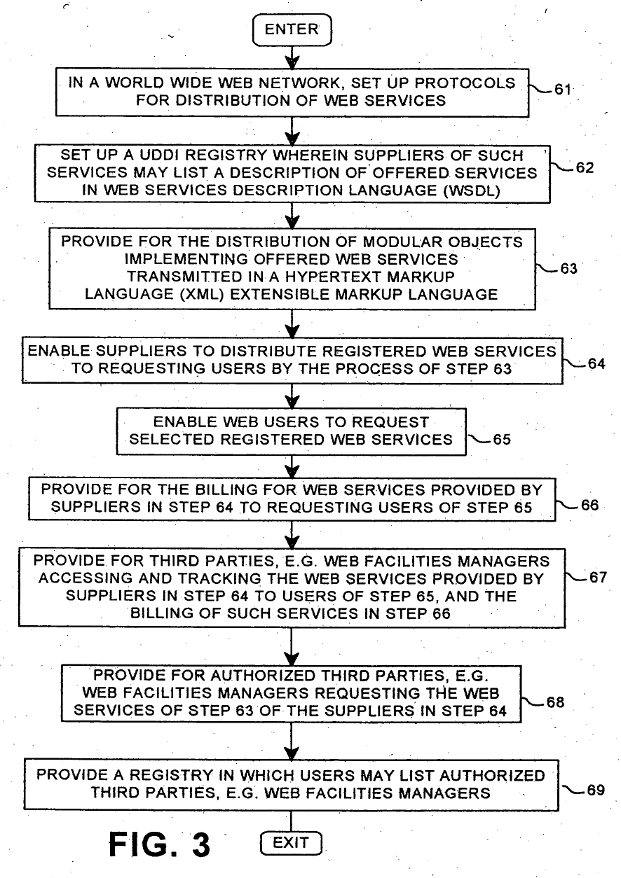

FIG. 3 is a flowchart showing the development of a process according to the present invention for distributing Web Services in a Web environment. Many of the programming functions in the process of FIG. 3 have already been described in general with respect to FIGS. 1 and 2. In a Web environment, the conventional protocols described above are set up for the conventional distribution of Web services, step 61. A UDDI registry is set up where suppliers of Web Services may list a description in WSDL of the service being offered, step 62. Provision is made for the distribution of modular objects from the supplier implementing the offered services that are transmitted in the markup language, XML, step 63. Suppliers are enabled, step 64, to distribute their registered Web Service components via the process of step 63. Users are enabled to request selected registered Web Services from selected registered suppliers, step 65. Provision is made, step 66, for the billing for Web Services provided by suppliers in step 64 to requesting users of step 65. Provision is made, step 67, for third parties, e.g. Web facilities managers, to access and track the Web services provided by suppliers in step 64 to requesting users of step 65, and the billing of such services in step 66. Provision is also made, step 68, for authorized third parties, e.g. the Web facilities managers, to request the Web services of step 63 from the suppliers of step 64. There is also provided a registry function within which users may list authorized third parties, e.g. Web facilities managers, step 69.

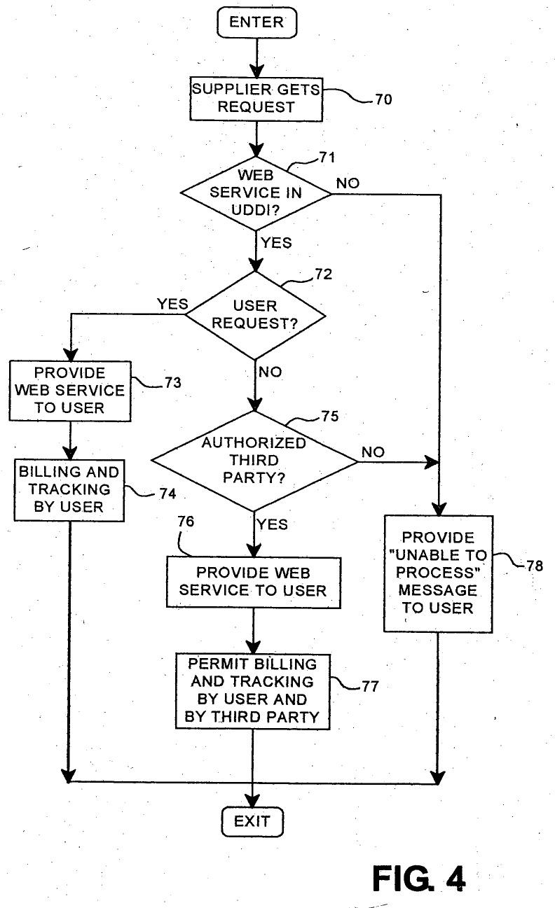

The running of the process set up in FIG. 3 will now be described with respect to the flowchart of FIG. 4. First, a supplier receives a request for a Web Service, step 70. A determination is made as to whether the requested Web Service has been registered along with the supplier in the UDDI, step 71. If Yes, a further determination is made as to whether the request is from an authorized user, step 72. If Yes, then the Web Service is provided to the requesting user, step 73, the user is billed and billing and tracking inquiries by user are enabled, step 74. If the decision from step 72 is No, a further determination is made as to whether this request is from a third party authorized to represent a particular user, step 75. If Yes, then the Web Service is provided to the user, step 76, and the user may be billed, but billing and tracking inquiries by both the user and third parties are enabled, step 77. It should also be noted that billing and tracking inquiries by authorized users or third parties are handled in a manner similar to requests for Web Services except that requested information is sent via the Web rather than a Web Service. Lastly, if the decision from either step 71 or 75 is No, then a message is sent to the requesting user: “Unable to process request.”

Although certain preferred embodiments have been shown and described, it will be understood that many changes and modifications may be made therein without departing from the scope and intent of the appended claims.

1. In a World Wide Web (Web) communication network with user access via a plurality of data processor controlled interactive Web display stations, a Web Service distribution system comprising:
a registry of platform independent Web Services available as integratable Web Service modules distributable over the Web from registered suppliers to requesting users;
means enabling suppliers to register said integrated Web Service modules being offered by said suppliers for distribution to users at said Web stations;
means enabling users of said Web Services to request distribution of such services to their respective Web stations;
means enabling said suppliers of said Web Services to bill users provided with said Web Services to bill requesting users for said Web Services provided over the Web; and
means enabling third parties to track said distribution and said billing via the Web.

2. The Web Services distribution system of claim 1 wherein said registry is a Universal Description, Discovery and Integration (UDDI) registry.

3. The Web Services distribution system of claim 1 wherein said Web Service modules distributed over the Web are defined in a text based markup language.

4. The Web Services distribution system of claim 3 wherein said text based markup language uses an Extensible Markup Language (XML) standard.

5. The Web Services distribution system of claim 4 wherein said distributed Web Service modules include interchangeable application program objects.

6. The Web Services distribution system of claim 4 wherein said third party enabled to track said distribution is an independent Web services manager for one selected from the group consisting of said suppliers and said users.

7. The Web Services distribution system of claim 5 wherein said users and suppliers access the Web through an Internet Service Provider (ISP), and said ISP includes said Web services manager.

8. In a Web communication network with user access via a plurality of data processor controlled interactive Web display stations, a method of Web Service distribution comprising:
providing a registry describing platform independent Web Services available as integratable Web Service modules distributable over the Web from registered suppliers to requesting users;
enabling suppliers to register said integrated Web Service modules being offered by said suppliers for distribution to users at said Web station;
enabling users of said Web Services to request distribution of such services to their respective Web stations;
enabling said suppliers of said Web Services to bill user provided with said Web Services to bill requesting users for said Web Services provided over the Web; and
enabling third parties to track said distribution and said billing via the Web.

9. The Web Services distribution method of claim 8 wherein said registry is defined by the UDDI standard.

10. The Web Services distribution method of claim 8 wherein said Web Service modules being distributed over the Web are defined in a text based markup language.

11. The Web Services distribution method of claim 10 wherein said text based markup language uses an XML standard.

12. The Web Services distribution method of claim 11 wherein said Web Service modules being distributed include interchangeable application program objects.

13. The Web Services distribution method of claim 11 wherein said third party enabled to track said distribution is an independent Web services manager for one selected from the group consisting of said suppliers and said users.

14. The Web Services distribution method of claim 12 wherein said users and suppliers access the Web through an ISP, and said ISP includes said Web services manager.

15. A computer program having code recorded on a computer readable medium for the distribution of Web Services in a Web communication network with user access via a plurality of data processor controlled interactive Web display stations comprising:
a registry of platform independent Web Services available as integratable Web Service modules distributable over the Web from registered suppliers to requesting users;
means enabling suppliers to register said integrated Web Service modules being offered by said suppliers for distribution to users at said Web station;
means enabling users of said Web Services to request distribution of such services to their respective Web stations;
means enabling said suppliers of said Web Services to bill users provided with said Web Services to bill requesting users for said Web Services provided over the Web; and
means enabling third parties to track said distribution and said billing via the Web.

16. The computer program of claim 15 wherein said registry is a UDDI registry.

17. The computer program of claim 15 wherein said Web Service modules distributed over the Web are defined in a text based markup language.

18. The computer program of claim 17 wherein said text based markup language uses an XML standard.

19. The computer program of claim 18 wherein said distributed Web Service modules include interchangeable application program objects.

20. The computer program of claim 18 wherein said third party enabled to track said distribution is an independent Web services manager for one selected from the group consisting of said suppliers and said users.

21. The computer program of claim 19 wherein said users and suppliers access the Web through an ISP, and said ISP includes said Web services manager.
